(19) United States
(12) Patent Application Publication
(10) Pub. No.: US 2009/0177513 A1
(43) Pub. Date: Jul. 9, 2009

(54) Device and Method for Dynamic Itinerary Planning and Tracking for Mobile Communications Device

(76) Inventors: Colin John Eckhart, Raleigh, NC (US); Kurt Schmidt, Chapel Hill, NC (US)

Correspondence Address: HARRITY & HARRITY, LLP, 11350 RANDOM HILLS ROAD, SUITE 600, FAIRFAX, VA, 22030, US

(21) Appl. No.: 11/938,891

(22) Filed: Jan. 4, 2008

(51) Int. Cl. G06Q 99/00

(52) U.S. Cl. 705/8

(57) ABSTRACT

A dynamic tracking application for a mobile communications device is disclosed. The dynamic tracking application enters itinerary events into the mobile communications device to create an itinerary. The itinerary events are plotted on a map that can be displayed by the mobile communications device. The itinerary is then executed by calculating and storing directions to get from one itinerary event to the next itinerary event and calculating and storing estimated departure and arrival times between itinerary events. This is compared to the current time and location of the mobile communications device to further determine whether the user can arrive on time at the next scheduled itinerary event based on the calculated time and distance to the next scheduled itinerary event. If not, the user is prompted to edit the itinerary or it can be done automatically.

### BRIEF DESCRIPTION OF THE DRAWINGS

FIG. 1 is an illustration of some of the internal components of a mobile communications device.

FIG. 2 is a data flow diagram setting out top level functions of embodiments of the present invention.

FIG. 3 is a flowchart pertaining to entering data to create a dynamic itinerary on a mobile communications device according to an embodiment of the present invention.

FIG. 4 is a flowchart pertaining to plotting itinerary data on a mobile communications device according to an embodiment of the present invention.

FIG. 5 is a flowchart pertaining to executing a dynamic itinerary on a mobile communications device according to an embodiment of the present invention.

FIG. 6 is a flowchart pertaining to editing data within a dynamic itinerary on a mobile communications device according to an embodiment of the present invention.

FIG. 7 is an example of a screen shot of an itinerary overlayed on a map according to an embodiment of the present invention.

### DETAILED DESCRIPTION OF THE INVENTION

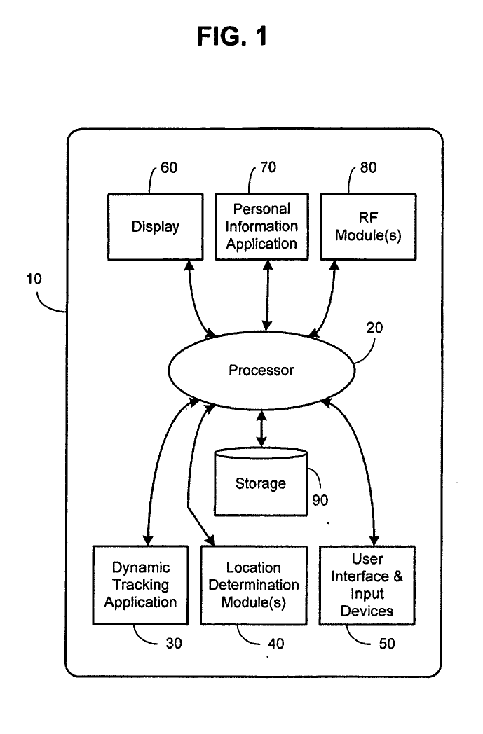

FIG. 1 is an illustration of some of the internal components of a mobile communications device 10. Within the mobile communications device 10 there are included several components that operate to practice the embodiments of the invention. Not all the components that comprise a mobile communications device 10 are illustrated, however.

A processor 20 serves to coordinate and control the operations and interactions among the various components. A dynamic tracking application 30 is executed by the processor to monitor and track the progress of a user's itinerary. To help track the user's itinerary, a location determination module 40 is used to provide instantaneous location information that is used to calculate distances among the user's current location and one or more event locations on the itinerary. A user interface and input devices 50 (e.g., keypad, scroll wheels, touchscreen, speaker, microphone, etc.) and a display 60 serve as the tools by which a user can input data to the system and have data presented by the system. Many mobile communications devices 10 also include a personal information application 70 that maintains calendar and contact data. The personal information application 70 can serve as a source of itinerary events that have been scheduled by the user into that application and can be ported into the dynamic tracking application 30. The mobile communications device 10 also includes one or more RF modules for sending and receiving voice, audio, or data wirelessly to and from the mobile communications device 10. One or more data storage devices 90 are also included within the mobile communications device 10.

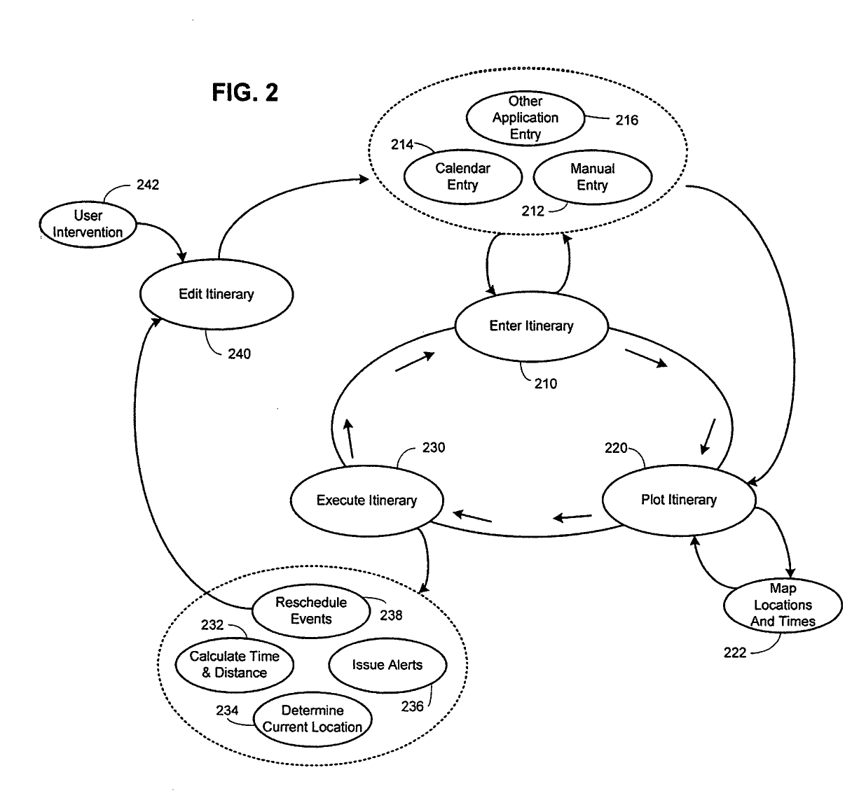

FIG. 2 is a data flow diagram setting out top level functions of embodiments of the present invention. There are four primary processes within the dynamic tracking application 30. These include an enter itinerary process 210, a plot itinerary process 220, an execute itinerary process 230, and an edit itinerary process 240.

The enter itinerary process 210 is used to create an itinerary. There can be manual entry procedures 212, calendar entry procedures 214, and other application entry procedures 216.

The manual entry procedures 212 contemplate the user utilizing the various user interface and input devices to manually input dates, times, and locations of events to be added to an itinerary. Manual entry procedures 212 can include, but is not limited to, keyboard entry, voice entry, and touchscreen entry.

The calendar entry procedures 214 allow for the user to port appointments from the calendar function into the dynamic tracking application as a means of creating an itinerary. This keeps the user from having to manually re-enter data that is already contained in another application. For instance, the user may have a 3:00 PM doctor's appointment in his calendar that can be ported to that day's itinerary application.

The other application entry procedures 216 allows the user to create itinerary entries using other mobile communication device 10 applications. The most obvious example would be a browsing application. The user can be browsing the web for movie times for a particular theater. Upon finding a suitable movie time, the user can select the entry and the data (title/showtime/theater address) can be automatically entered into the itinerary. The other application entry procedures 216 can also work in conjunction with the manual entry procedures 212 to make it easier for the user to add to the itinerary. For instance, a user can be web browsing for a restaurant. The user can similarly select a restaurant from the browser application and have its address ported into the dynamic tracking application. The user is then prompted to manually enter the time desired to arrive at the restaurant. This saves the user the trouble of manually entering the address (location) of the restaurant and only requires a time entry.

The plot itinerary process 220 is used to map the locations and times 222 of events on the itinerary onto a map display that can be presented to the user via the mobile communication device display 60. The events are overlayed in their correct location on a map. The map can be zoomed in and out and/or shifted in any direction (north, south, east, west) to suit the user's viewing desires. Once plotted, the user can view his itinerary on a map with the event locations highlighted and a time associated with each event. The dynamic tracking application can also provide a pop-up type of information display that will provide more detailed information for the event if the user scrolls across the event in the map display.

The execute itinerary process 230 begins once an itinerary has been plotted and the temporal limitations are relevant. For instance, the dynamic tracking application will not execute Thursday's itinerary if it is Wednesday. The sub-processes of the execute itinerary process 230 include calculating time and distance parameters 232 between current locations and events, determining the current location 234, issuing alerts 236 informing the user of itinerary progress, and initiating event re-scheduling 238 should it become necessary.

The edit itinerary process 240 allows the user to make changes to an itinerary for a variety of reasons. A user may be falling behind because he is spending more time than the itinerary allows at one event. This may require deleting an event or shifting the times of the events to accommodate the extra time being spent at the current event. The user may simply wish to add, delete, or change event parameters by choice. The user always has an intervention 242 option that allows access to the itinerary for purposes of editing the itinerary.

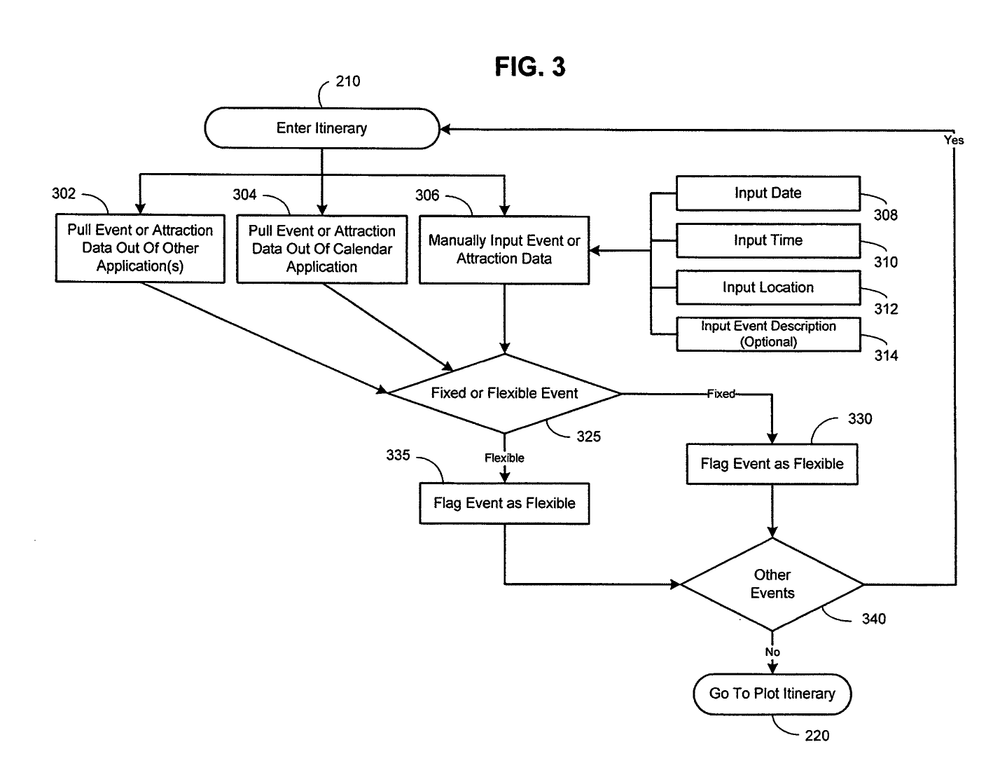

FIG. 3 is a more detailed flowchart pertaining to entering data to create a dynamic itinerary 210 on a mobile communications device according to an embodiment of the present invention. As mentioned earlier, there are three options for entering data into an itinerary; pulling event data out of other applications 302, pulling events out of a calendar application 304, and manually entering event data. An itinerary can be created using any one or any combination of the three options.

Pulling event data out of other applications 302, such as a web-browser for instance, involves finding an event and selecting it using the web-browsing tools available to the user. Once selected, the user has the option to import the event into the dynamic tracking application as an itinerary entry. The data that gets imported includes time and location data for the event (e.g., a movie theatre address and show-time) and (optionally) any other descriptive event information.

Pulling event data out of a calendar application 304 involves selecting one or more calendar entries for importation into the dynamic tracking application as an itinerary entry. The data that gets imported includes time and location data for the event and (optionally) any other descriptive event information.

Manually entering event data 306 involves having the user manually input a date 308, a time 310, a location 312, and (optionally) descriptive information 314 for an event. Once an event is entered, the user can be queried as to whether the event is a fixed event (one that can not be or is not easily re-scheduled) or a flexible event 325.

If the event is determined to be fixed it is flagged as such 330 and then the user is queried whether there are other events to add to the itinerary 345. If so, control is returned to the enter itinerary block 210 where the process repeats. Otherwise, control is passed to the plot itinerary process 220.

If the event is determined to be flexible it is flagged as such 335 and then the user is queried whether there are other events to add to the itinerary 345. If so, control is returned to the enter itinerary block 210 where the process repeats. Otherwise, control is passed to the plot itinerary process 220.

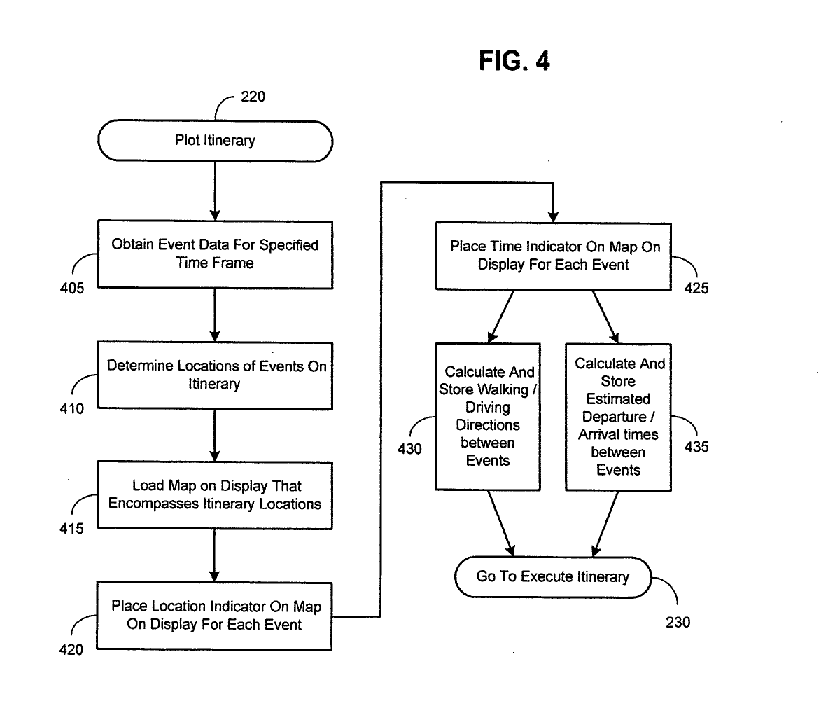

FIG. 4 is a more detailed flowchart pertaining to plotting itinerary data on a mobile communications device according to an embodiment of the present invention. The plot itinerary process 220 begins by obtaining the event data 405 previously entered during the enter itinerary 210 (or edit itinerary 240) process. The locations of the obtained events are then determined 410. A street map of an area that encompasses the event locations is then loaded and displayed 415. An icon is then placed on the map corresponding to the location of each event 420. A time indicator can also be associated with the location icon for each event displayed on the map 425. The dynamic tracking application also calculates and stores walking and/or driving directions between events 430 as well as estimated departure and arrival times between events 435. The dynamic tracking application is now ready to execute the itinerary 230.

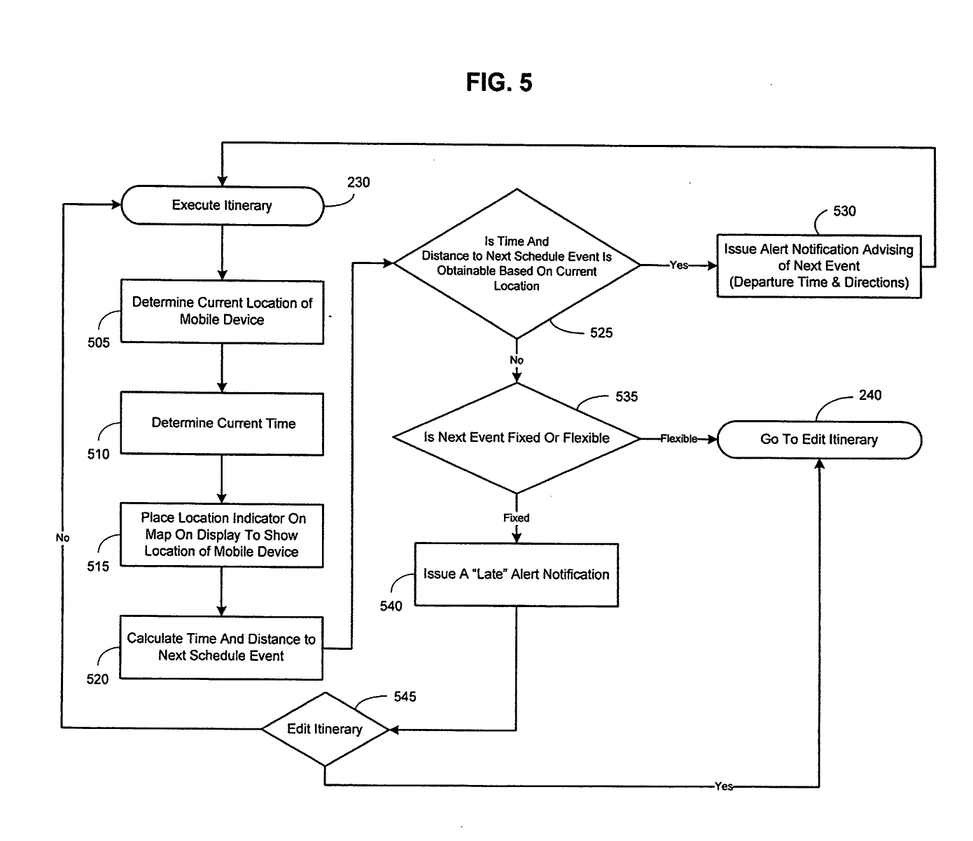

FIG. 5 is a more detailed flowchart pertaining to executing a dynamic itinerary on a mobile communications device according to an embodiment of the present invention. The execute itinerary process 230 in the dynamic tracking application begins by determining the current location of the mobile communications device 505 using the location determination module included with the mobile communications device 10. The current time is also determined 510. Once the current location of the mobile communications device has been determined, it can be plotted on the map on the display 515 indicating the user's current location relative to the itinerary events. The execute itinerary process can then calculate a time and distance from the current location to the next scheduled event 520 on the itinerary. This result of this calculation is then analyzed to determine if the user is on schedule to arrive at the next event 525. This analysis can use historical data that provides estimates of how quickly the user usually takes to walk or drive between points.

If the dynamic tracking application determines that the user is on schedule, it will issue an alert 530 to the user advising of the next event. The alert can include an estimated time of arrival based on walking/driving/cycling (whichever transportation mode is most applicable) and provide directions to get to the next event. Control is then returned to the beginning of the execute process. The user's position is periodically updated and the dynamic tracking application will monitor the user's progress to ensure that the user is on track to keep his itinerary.

If the dynamic tracking application determines that the user is not on schedule, it can check to see if the next scheduled event is a fixed event or a flexible event 535. If the event happens to be a fixed event, then a “Late” alert notification can be presented to the user 540. The user can then be prompted whether he wishes to edit the itinerary 545. If he chooses not to edit the itinerary, the execution process continues. Otherwise, control is passed to the edit itinerary process 240.

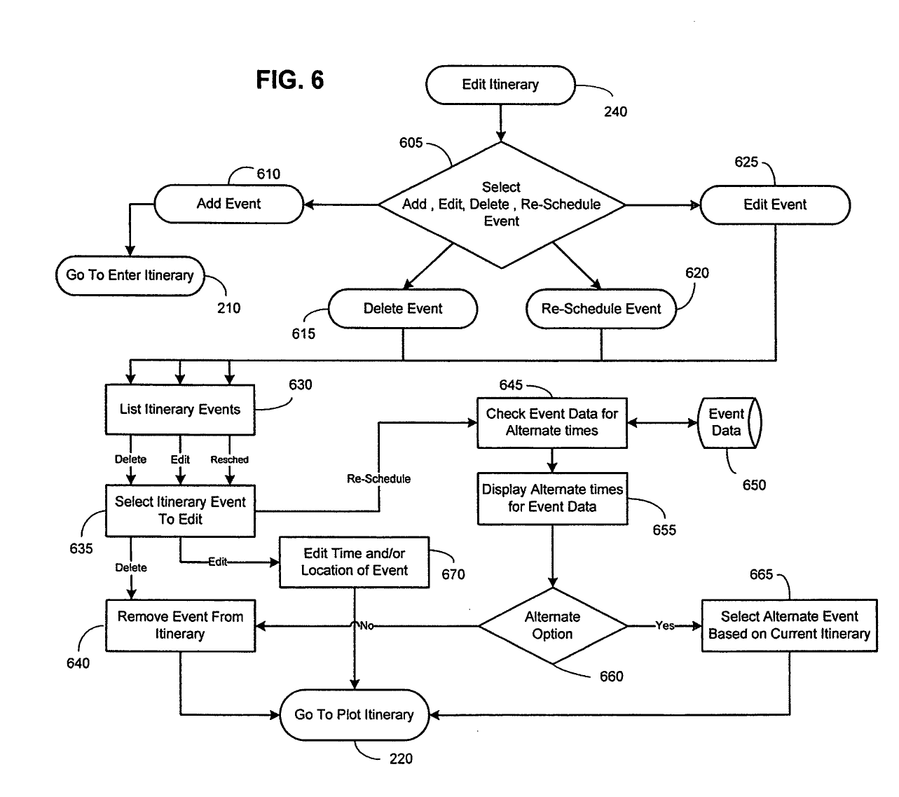

FIG. 6 is a flowchart more detailed pertaining to editing data within a dynamic itinerary on a mobile communications device according to an embodiment of the present invention. The edit itinerary process 240 includes adding itinerary events 610, deleting itinerary events 615, re-scheduling itinerary events 620, and editing itinerary events 625. The user is prompted 605 to select one of these options.

If the user opts to add itinerary events 610, control is routed to the enter itinerary process 210. If the user opts to delete an event 615, the first step is to list the itinerary events 630 so that the user can select an itinerary event 635. The selected itinerary event is then deleted from the itinerary 640. Control is then sent to the plot itinerary process 220 so that the new itinerary can be recalculated and re-plotted.

If the user opts to re-schedule an event 620, the first step is to list the itinerary events 630 so that the user can select an itinerary event 635. The selected event is then checked to see if there are alternate times associated with the event 645. For instance, if the event were a movie, the application would check event data storage 650 for additional showtimes. Any alternate times for the selected event can be displayed 655. The dynamic tracking application then determines if there are viable alternate options 660. If not, the event can be removed 640 from the itinerary and the itinerary can be re-plotted 220. Otherwise, the user can then select one of the alternate times for the event 665. Control is then sent back to the plot itinerary process 220 to re-plot the itinerary based on the re-scheduled event.

If the user opts to edit an event 620, the first step is to list the itinerary events 630 so that the user can select an itinerary event 635. Once the event has been selected, the user can edit the time and/or location of the event manually 670. Control is then sent back to the plot itinerary process 220 to re-plot the itinerary based on the edited event.

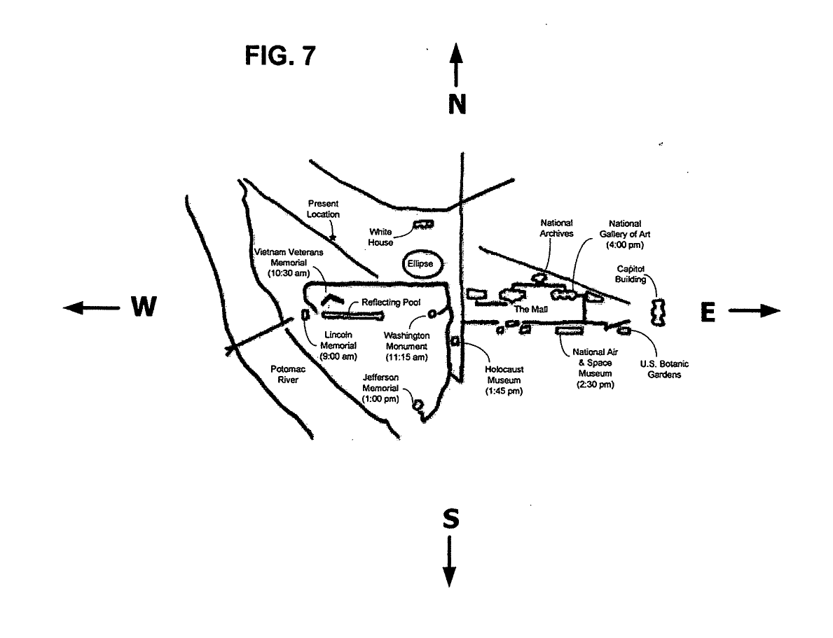

FIG. 7 is an example of a screen shot of an itinerary overlayed on a map according to an embodiment of the present invention. In this example, the user has created an itinerary for a day of sight-seeing in Washington D.C. The mapped area encompasses a variety of sight-seeing destinations that the user has selected to visit and a time-line for visiting them. This itinerary starts at the Lincoln Memorial at 9:00 am and proceeds to the Vietnam Veterans Memorial at 10:30 am onto the Washington Monument at 11:15 am and the Jefferson Memorial at 1:00 pm. The afternoon continues with stops at the Holocaust Museum at 1:45 pm, the National Air & Space Museum at 2:30 pm and finishing at the National Gallery of Art at 4:00 pm.

The map indicates that the user has opted to start his sight-seeing tour at the Lincoln Memorial at 9:00 am. The user's present location is also shown on the map using a star icon, for instance. While the illustrations herein do not show color, color can be used to help highlight and distinguish many of the characteristics on the map. The dynamic tracking application can compare the user's current location and the current time against the first event on the itinerary to map a route and inform the user when to start transporting to the event.

The next stop on the sight-seeing tour is the Vietnam Veterans Memorial at 10:30. If the user is spending more than the allocated time at the first stop (Lincoln Memorial), the dynamic tracking application can alert the user that he needs to prepare to leave in five minutes, for instance, in order to arrive at the next event on time. The same process is followed as the user arrives and departs from each scheduled event. If at any time, the user wishes to add to or edit the itinerary or re-schedule an event, he may access the itinerary and effect such changes as described above.

Additional levels of intelligence within the system (e.g., mobile communications device and/or mobile network infrastructure of service provider) can provide further features and enhancements to the system. The more information the system has within its possession, the more the dynamic tracking application can automatically re-configure the user's itinerary.

As the user visits the sights on their itinerary the location data in the mobile is used to predict when the user will be at the next attraction. This can be done through the calculation of over land speed, in combination with the amount of time the user spends at the attraction. User information such as walking speed, frequency of stops in a given area, and duration of stops can be compared with historical data of other users that have visited a particular attraction and others on the itinerary to predict the time needed to visit each attraction. The user's real velocity vector when walking from one attraction to another accounting for velocity variations due to incidental sights can be used to automatically refine the itinerary.

Some common data elements that can be used in automatically refining an itinerary include: scheduled show times, transit distances and fixed transit periods (e.g., train/bus schedules and transit times). Using data such as this, the mobile communications device can dynamically re-order and re-configure an itinerary to maximize the enjoyment of the trip while minimizing disappointments due to missed events or tours.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any prompts associated with the present invention may be presented and responded to via a graphical user interface (GUI) presented on the display of the mobile communications device or the like. Prompts may also be audible, vibrating, etc.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method of itinerary planning and tracking on a mobile communications device that includes a display comprising:
entering one or more itinerary events into the mobile communications device to create an itinerary;
plotting the one or more itinerary events on a map that can be displayed by the mobile communications device; and
executing the itinerary.

2. The method of claim 1 wherein entering one or more itinerary events into the mobile communications device to create an itinerary comprises at least one of:
porting date, time, and location data for an itinerary event from a browsing application that has access to one or more external networks;
porting date, time, and location data for an itinerary event from a calendar application also resident on the mobile communications device; and
accepting manual input including a date, time, and location for an itinerary event from one or more user interface or input devices integrated into or coupled with the mobile communications device.

3. The method of claim 2 further comprising flagging an itinerary event as being fixed or flexible.

4. The method of claim 3 wherein plotting the one or more itinerary events on a map that can be displayed by the mobile communications device comprises:
initially loading a map on the mobile communications device display that encompasses an area large enough to hold each of the itinerary events; and
placing a location icon on the map at each itinerary event location.

5. The method of claim 4 wherein plotting the one or more itinerary events on a map that can be displayed by the mobile communications device further comprises:
displaying the itinerary event time data with the location icon for each itinerary event on the map;
calculating and storing directions to get from one itinerary event to the next itinerary event; and
calculating and storing estimated departure and arrival times between itinerary events.

6. The method of claim 4 wherein executing the itinerary comprises:
determining the current location of the mobile communications device;
determining the current time;
placing a location icon on the map indicative of the current location of the mobile communications device;
calculating the time and distance to the next scheduled itinerary event; and
determining whether the user can arrive on time at the next scheduled itinerary event based on the calculated time and distance to the next scheduled itinerary event.

7. The method of claim 6 wherein executing the itinerary further comprises:
if it is determined that the user can arrive on time at the next scheduled itinerary event based on the calculated time and distance to the next scheduled itinerary event, then
issuing an alert advising of the next itinerary event wherein the alert includes a recommended departure time and directions to the next scheduled itinerary event; and
if it is determined that the user can not arrive on time at the next scheduled itinerary event based on the calculated time and distance to the next scheduled itinerary event, then
determining whether the next scheduled itinerary event has been flagged as fixed or flexible, and if fixed issuing an alert advising that the next itinerary event can not be reached in time wherein the alert includes a prompt asking whether to edit the itinerary, and if flexible issuing an alert wherein the alert includes a prompt asking whether to edit the itinerary.

8. The method of claim 6 wherein executing the itinerary further comprises automatically re-scheduling the itinerary if it is determined that the user can not arrive on time at the next scheduled itinerary event based on the calculated time and distance to the next scheduled itinerary event.

9. The method of claim 1 further comprising:
editing an itinerary wherein editing includes one or more of adding an itinerary event, deleting an itinerary event, re-scheduling an itinerary event, and editing an itinerary event; and
replotting the edited itinerary upon completion of editing the itinerary.

10. A computer readable medium storing a computer program product for itinerary planning and tracking on a mobile communications device that includes a display, the computer readable medium comprising:
computer program code for entering one or more itinerary events into the mobile communications device to create an itinerary;
computer program code for plotting the one or more itinerary events on a map that can be displayed by the mobile communications device; and
computer program code for executing the itinerary.

11. The computer readable medium of claim 10 wherein the computer program code for entering one or more itinerary events into the mobile communications device to create an itinerary comprises at least one of:
computer program code for porting date, time, and location data for an itinerary event from a browsing application that has access to one or more external networks;
computer program code for porting date, time, and location data for an itinerary event from a calendar application also resident on the mobile communications device; and
computer program code for accepting manual input including a date, time, and location for an itinerary event from one or more user interface or input devices integrated into or coupled with the mobile communications device.

12. The computer readable medium of claim 11 further comprising computer program code for flagging an itinerary event as being fixed or flexible.

13. The computer readable medium of claim 12 wherein the computer program code for plotting the one or more itinerary events on a map that can be displayed by the mobile communications device comprises:
computer program code for initially loading a map on the mobile communications device display that encompasses an area large enough to hold each of the itinerary events, and
computer program code for placing a location icon on the map at each itinerary event location.

14. The computer readable medium of claim 13 wherein the computer program code for plotting the one or more itinerary events on a map that can be displayed by the mobile communications device further comprises:
computer program code for displaying the itinerary event time data with the location icon for each itinerary event on the map;
computer program code for calculating and storing directions to get from one itinerary event to the next itinerary event; and
computer program code for calculating and storing estimated departure and arrival times between itinerary events.

15. The computer readable medium of claim 13 wherein the computer program code for executing the itinerary comprises:
computer program code for determining the current location of the mobile communications device;
computer program code for determining the current time;
computer program code for placing a location icon on the map indicative of the current location of the mobile communications device;
computer program code for calculating the time and distance to the next scheduled itinerary event; and
computer program code for determining whether the user can arrive on time at the next scheduled itinerary event based on the calculated time and distance to the next scheduled itinerary event.

16. The computer readable medium of claim 15 wherein the computer program code for executing the itinerary further comprises:
if it is determined by the computer program code for determining whether the user can arrive on time at the next scheduled itinerary event based on the calculated time and distance to the next scheduled itinerary event that the user can arrive on time at the next scheduled itinerary event based on the calculated time and distance to the next scheduled itinerary event, then
computer program code for issuing an alert advising of the next itinerary event wherein the alert includes a recommended departure time and directions to the next scheduled itinerary event; and
if it is determined by the computer program code for determining whether the user can arrive on time at the next scheduled itinerary event based on the calculated time and distance to the next scheduled itinerary event that the user can not arrive on time at the next scheduled itinerary event based on the calculated time and distance to the next scheduled itinerary event, then
computer program code for determining whether the next scheduled itinerary event has been flagged as fixed or flexible, and if fixed computer program code for issuing an alert advising that the next itinerary event can not be reached in time wherein the alert includes a prompt asking whether to edit the itinerary, and if flexible computer program code for issuing an alert wherein the alert includes a prompt asking whether to edit the itinerary.

17. The computer readable medium of claim 15 wherein the computer program code for executing the itinerary further comprises computer program code for automatically re-scheduling the itinerary if it is determined that the user can not arrive on time at the next scheduled itinerary event based on the calculated time and distance to the next scheduled itinerary event.

18. The computer readable medium of claim 10 further comprising:
computer program code for editing an itinerary wherein editing includes one or more of adding an itinerary event, deleting an itinerary event, re-scheduling an itinerary event, and editing an itinerary event; and
computer program code for re-plotting the edited itinerary upon completion of editing the itinerary.

19. A system for itinerary planning and tracking on a mobile communications device, the mobile communications device comprising:
a processor for executing the various software components of the mobile communications device;
a display coupled with the processor;
a location determination module coupled with the processor; and
a dynamic tracking application coupled with the processor for:
entering one or more itinerary events into the mobile communications device to create an itinerary;
plotting the one or more itinerary events on a map that can be displayed by the mobile communications device; and
executing the itinerary.

20. The system of claim 19 wherein entering one or more itinerary events into the mobile communications device to create an itinerary comprises at least one of:
porting date, time, and location data for an itinerary event from a browsing application that has access to one or more external networks;
porting date, time, and location data for an itinerary event from a calendar application also resident on the mobile communications device; and
accepting manual input including a date, time, and location for an itinerary event from one or more user interface or input devices integrated into or coupled with the mobile communications device.

21. The system of claim 20 further comprising flagging an itinerary event as being fixed or flexible.

22. The system of claim 21 wherein plotting the one or more itinerary events on a map that can be displayed by the mobile communications device comprises:
initially loading a map on the mobile communications device display that encompasses an area large enough to hold each of the itinerary events; and
placing a location icon on the map at each itinerary event location.

23. The system of claim 22 wherein plotting the one or more itinerary events on a map that can be displayed by the mobile communications device further comprises:
displaying the itinerary event time data with the location icon for each itinerary event on the map;
calculating and storing directions to get from one itinerary event to the next itinerary event; and
calculating and storing estimated departure and arrival times between itinerary events.

24. The system of claim 22 wherein executing the itinerary comprises:
determining the current location of the mobile communications device;
determining the current time;
placing a location icon on the map indicative of the current location of the mobile communications device;
calculating the time and distance to the next scheduled itinerary event; and
determining whether the user can arrive on time at the next scheduled itinerary event based on the calculated time and distance to the next scheduled itinerary event.

25. The system of claim 24 wherein executing the itinerary further comprises:
if it is determined that the user can arrive on time at the next scheduled itinerary event based on the calculated time and distance to the next scheduled itinerary event, then
issuing an alert advising of the next itinerary event wherein the alert includes a recommended departure time and directions to the next scheduled itinerary event; and
if it is determined that the user can not arrive on time at the next scheduled itinerary event based on the calculated time and distance to the next scheduled itinerary event, then
determining whether the next scheduled itinerary event has been flagged as fixed or flexible, and if fixed issuing an alert advising that the next itinerary event can not be reached in time wherein the alert includes a prompt asking whether to edit the itinerary, and if flexible issuing an alert wherein the alert includes a prompt asking whether to edit the itinerary.

26. The system of claim 24 wherein executing the itinerary further comprises automatically re-scheduling the itinerary if it is determined that the user can not arrive on time at the next scheduled itinerary event based on the calculated time and distance to the next scheduled itinerary event.

27. The system of claim 19 further comprising:
editing an itinerary wherein editing includes one or more of adding an itinerary event, deleting an itinerary event, re-scheduling an itinerary event, and editing an itinerary event; and
re-plotting the edited itinerary upon completion of editing the itinerary.
